(19) United States
(12) Patent Application Publication
(10) Pub. No.: US 2020/0193822 A1
(43) Pub. Date: Jun. 18, 2020

(54) METHOD OF DYNAMIC DIVISION OF MULTI-LAYER CONTROL BOUNDARY OF OVER-SATURATED ROAD NETWORK BASED ON MFD UNDER TELEMATICS

(71) Applicant: Guang Dong Communication Polytechnic, Guangdong (CN)

(72) Inventors: Xiaohui LIN, Guangdong (CN); Chengtao CAO, Guangdong (CN); Liang HUANG, Guangdong (CN); Gengqi GUO, Guangdong (CN)

(73) Assignee: Guang Dong Communication Polytechnic, Guangdong (CN)

(21) Appl. No.: 16/474,550

(22) PCT Filed: Apr. 8, 2018
(86) PCT No.: PCT/CN2018/082139

§ 371 Date: Jun. 28, 2019

(30) Foreign Application Priority Data
Dec. 6, 2017 (CN) 201711278306.3

(51) Int. Cl. G08G 1/0967; G08G 1/01

(52) U.S. Cl. CPC G08G 1/096775; G08G 1/0125; G06F 17/11; G08G 1/0141; G08G 1/0145

(57) ABSTRACT

The present invention relates to a method of dynamic division of multi-layer control boundary of an over-saturated road network based on MFD under telematics, in an internet of vehicles environment, and according to an MFD reference database, determining traffic conditions of respective minimum units in a street network, expanding sequentially from a central key node to peripheral nodes, until a boundary of a congestion region is determined, so as to establish three control boundaries, namely those for the congestion region, a transition region and a normal region in the street network. If a street network has a plurality of congestion regions, a plurality of control boundaries can be set dynamically.

### BACKGROUND

### Technical Field

The present invention relates to the technical field of control method, and more specifically, relates to a method of dynamic division of multi-layer control boundary of an over-saturated road network based on MFD under telematics.

### Description of Related Art

With the rapid development of social economy, urban traffic congestion is intensifying, posing great challenges to urban traffic. In order to solve the problem of ill-conditioned traffic in cities, many scholars have proposed various control strategies, being able to effectively alleviate traffic congestion to a certain extent. However, as traffic flows continue to accumulate towards the center of the road network, it leads to a situation of over-saturated traffic flow in the road network, and various control strategies appear to be incapable. Recently, the relevant theories of Macroscopic Fundamental Diagrams (MFD) were revealed by two scholars, Daganzo and Geroliminis. They believe that each road network has its own MFD, reflecting the relationship between the number of moving vehicles and the weighted traffic flow of road segments. Also, this MFD is only related to its road network structure, and is not related to factors such as cycle and traffic size. It is an inherent attribute of the road network. A number of scholars have also verified the objective existence of MFD, and some scholars have proposed various MFD-based road network management strategies. For example, Xunxun Zhang et al. proposed to divide the urban road network into a plurality of sub-areas, the traffic flow of each sub-area is divided into internal flow and transfer flow, and a MFD-based multi sub-area traffic flow model is established. Heng Ding et al. proposed to fixedly partition control sub-area based on homogeneous road network MFD; by analyzing the relationship of vehicle inflow and outflow among sub-areas, an optimal control model of the boundary of the congested area is established; and this model takes the highest completion rate of road network travel vehicles and the lowest number of vehicles blocked at the boundary of sub-areas as the optimization goal. Jing Zhao et al. considered the MFD characteristics of two sub-areas and the in and out relationship of the traffic flow, and proposed a game control logic and its solving process aiming at maximizing the overall operational benefit of the two sub-areas. The inventor of the present invention has proposed a traffic limiting strategy of single-layer boundary that limits the influx of surrounding traffic flow. All of the above methods can effectively perform macro management on the road network and reasonably play the role of traffic control facilities under over-saturated status. However, all of the control sub-areas described in the above methods are executed with various control strategies after pre-defined by experienced engineers. There are factors that sub-areas are inaccurately defined.

### SUMMARY

An object of the prevent invention is to overcome the drawbacks of the prior art, and to provide a method of dynamic division of multi-layer control boundary of an over-saturated road network based on MFD under telematics. Under the environment of telematics, according to a MFD reference library, a sequential expansion is performed from the center key nodes to the peripheral nodes, to determine the traffic state of the smallest unit of each road network until the boundary of the congested area of the road network is determined. Thus, a three-layer road network control boundary including a congested area, a transition area, and a normal area is established. If there are multiple congested areas in the road network, the road network multi-layer control boundary can be dynamically divided.

In order to solve the abovementioned technical problems, the technical solution adopted by the present invention is as follows.

A method of dynamic division of multi-layer control boundary of an over-saturated road network based on MFD under telematics is provided, and specific steps are as follows:

(a) firstly, establishing a road network model;

(b) after the step (a), establishing a MFD reference library of a road network;

(c) after the step (b), obtaining traffic parameters of the road network under an environment of telematics;

(d) after the step (c), under the environment of telematics, collecting a number NCRu of moving vehicles of a center minimum unit CRu of the road network in real time; according to the MFD reference library, determining a traffic state of the center minimum unit of the road network; if the center minimum unit of the road network is in a non-congested state, the road network does not have a congested area; if the center minimum unit of the road network is in a congested state, it is defined as a congested area; then judging a traffic state of a minimum unit of the road network of adjacent nodes thereof to determine a boundary node of the congested area; and

(e) after the step (d), defining a peripheral node near the boundary node of the congested area as a transition node, defining an area expanded by the periphery of the transition node as a traffic normal area, defining a peripheral node near the transition node as an inner node of the traffic normal area, defining a zone between the inner node of the traffic normal area and the boundary node of the congested area as a traffic transition area; by determining if road segments connected between the transition node and the traffic normal node are in the non-congested state or the congested state, it can thereby be judged that if boundary control are performed to these road segments and the boundary node is checked and approved.

The present invention provides a method of dynamic division of multi-layer control boundary of an over-saturated road network based on MFD under telematics. Under the environment of telematics, according to the MFD reference library, a sequential expansion is performed from center key nodes to peripheral nodes, to judge the traffic state of the smallest unit of each road network until the boundary of the congested area of the road network is determined. Thus, a three-layer road network control boundary including a congested area, a transition area, and a normal area is established. If there are multiple congested areas in the road network, the road network multi-layer control boundary can be dynamically divided.

Preferably, in the step (a), road intersections are positioned as nodes, each of the road segments is a line segment connecting each node, thereby a road network model based on connection of the road segments is established, and a formula is as follows:

$$\{ \begin{matrix}{R}_{w} = ( M , R , {L}_{R} ) \\ R = \{ ( i , j ) \text{\textbar} i , j ∈ M , and L ( i , j ) \} \\ {L}_{R} = \{ {l}_{ij} \text{\textbar} ( i , j ) ∈ R \}\end{matrix}$$

wherein R_{w} is a city road network;

M is a set of the intersections;

R is a set of the road segments, wherein elements thereof are ordered pairs (i, j), and L(i, j) indicates that there is a directed path from an intersection i to an intersection j;

L_{R} is a set of length of the road segments, wherein its element lij indicates a length of a directed road segment (i, j).

Preferably, in the step (b), the step of establishing the MFD reference library of the road network is as follows:

(a) firstly, collecting the historical traffic data of the road network and generating a MFD of a minimum unit of each road network, and a formula is as follows:

$$\{ \begin{matrix}{N}_{i} = {\sum }_{ij} {k}_{ij} {l}_{ij} \\ {q}_{i}^{w} = {\sum }_{ij} {q}_{ij} {l}_{ij} \text{/} {\sum }_{ij} {l}_{ij}\end{matrix}$$

wherein Nᵢ is a number (pcu) of the moving vehicles of the minimum unit of the road network at an i-th node;

kᵢⱼ is a traffic density (pcu/km) of the minimum unit of the road network of the i-th node;

Iᵢⱼ is a road length (km) from the i-th node to an adjacent j-th node;

qᵢ^{w} is an amount (pcu/h) of a weighted traffic flow of the minimum unit of the road network of the i-th node;

qij is a flow (pcu/h) from the i-th node to the adjacent j-th node; and

(b) secondly, according to the MFD of the minimum unit of the road network at certain node, determining a critical number of vehicles and a maximum weighted traffic flow of the minimum unit of the road network at this node, and establishing the MFD reference library of the minimum unit of all road networks, and a formula is as follows:

MFD_{w}={(N_{C(i)},q_{c(i)}^{w})|∈M}

wherein MFD_{w} is a set of the MFD of the minimum unit of the road network at all nodes of the road networks;

N_{C(i)} is a critical number of vehicles of the minimum unit of the road network at the i-th node;

q_{c(i)}^{w} is an amount of a weighted traffic flow of the minimum unit of the road network of the i-th node.

Preferably, in the step (c), a ray method is used to judge whether a vehicle falls within a road network area, and specific steps are as follows: directing a ray from a latitude and longitude point of the vehicle to be judged to a certain direction, and calculating a number of intersections with boundaries of the road network. If the number is even or 0, the point is outside the road network area. If the number is odd, the point is inside the road network area. Specifically, in the environment of telematics, the vehicles are all equipped with a GPS onboard device, and are able to transmit information such as latitude, longitude and speed to a roadside unit in real time. At this time, it is judged whether a moving vehicle (a vehicle with an average speed equal or greater than 5 km/h) falls in the road network area, and it is equivalent to judge whether the point falls within a polygon area. Usually, the ray method can be used to judge whether the vehicle falls within the road network area. The fundamental idea is to direct the ray from a latitude and longitude point of the vehicle to be judged to the certain direction, and calculate the number of intersections with the boundaries of the road network. If the number is even or 0, the point is outside the road network area, and if it is odd, the point is inside the road network area.

Preferably, in the step (c), a number of vehicles falling within the road network area is converted into an equivalent amount of traffic, and a number Nᵢⱼ of vehicles of each road segment in the road network and an amount qᵢⱼ of a traffic flow of each road segment are determined (ij represents a road segment from the i-th node to an adjacent node j), thereby a traffic density K_{Ru(i)} of the minimum unit of each road network in the road networks is calculated. An average value of the traffic density of each road segment that connects a certain node, is defined a traffic density of the minimum unit of the road network of this node, and a formula is as follows:

$$\{ \begin{matrix}{k}_{ij} = \frac{{N}_{ij}}{{l}_{ij} * {n}_{ij}} , and {l}_{ij} \neq 0 \\ {K}_{i} = \{ ( {k}_{ij} \text{\textbar} i , j ∈ R , and {l}_{ij} \neq 0 \} \\ {K}_{Ru ( i )} = {\overline{K}}_{i}\end{matrix}$$

wherein Nᵢⱼ is a number (pcu) of moving vehicles of a road segment from the i-th node to an adjacent j-th node;

Iᵢⱼ is a length (km) of the road segment from the i-th node to the adjacent j-th node;

nᵢⱼ is a number of lanes of the road segment from the i-th node to the adjacent j-th node;

kᵢⱼ is a traffic density (pcu/km) of the road segment from the i-th node to the adjacent j-th node;

Kᵢ is a set of the traffic density of each road segment that connects with the i-th node;

K̅ᵢ is an average value (pcu/km) of traffic density of the i-th node;

K_{Ru(i)} is a traffic density (pcu/km) of the minimum unit of the road network of the i-th node.

Preferably, in the step (c), a node with a maximum value of average traffic density is used as a center key node of the road network, each road segment that connects with the center key node together form a center minimum unit CRu of the road network and a formula is as follows:

Kₘₐₓ=max(K_{Ru(1)},K_{Ru(2)}, . . . , K_{Ru(i)}, . . . , K_{Ru(n))}

wherein Kₘₐₓ is a traffic density (pcu/km) of the minimum unit of the center key node of the road network.

Preferably, in the step (d), specific steps of determining the boundary node of the congested area are as follows:

defining the center minimum unit of the road network in the congested state as the congestion area; then judging a traffic state of the minimum unit of the road network of an adjacent node. If the minimum unit of the adjacent node is in the non-congested state, the adjacent node is the boundary node of the congested area, and it is continued to judge the traffic state of the minimum unit of the next adjacent node. If the minimum unit of the adjacent node is in the congested state, the adjacent node is merged into the congestion area, and it is continued to judge the traffic state of the minimum unit of the next adjacent node. Then, the node newly merged into the congestion area is taken as a research object, and it is continued to judge the traffic state of the minimum unit of the road network of the adjacent node thereof until the boundary node of the congestion area is determined.

In comparison with the prior art, beneficial effects of the present invention are described in the following.

The present invention provides a method of dynamic division of multi-layer control boundary of an over-saturated road network based on MFD under telematics. Under the environment of telematics, according to a MFD reference library, a sequential expansion is performed from the center key nodes to the peripheral nodes, to determine the traffic state of the smallest unit of each road network until the boundary of the congested area of the road network is determined. Thus, a three-layer road network control boundary including a congested area, a transition area, and a normal area is established. If there are multiple congested areas in the road network, the road network multi-layer control boundary can be dynamically divided.

### BRIEF DESCRIPTION OF THE DRAWINGS

FIG. 1 is a flow diagram of a method of dynamic division of multi-layer control boundary of an over-saturated road network based on MFD under telematics according to an embodiment.

FIG. 2 is a schematic diagram of a multi-layer boundary of the road network according to an embodiment.

FIG. 3 is a microscopic simulation model of a part of the road network in Tianhe District, Guangzhou according to an embodiment.

FIG. 4 are MFD graphs of the minimum units of the road network of a part of intersections.

FIG. 5 is a schematic diagram of multi-layer control boundary of the part of the road network in the Tianhe District according to an embodiment.

FIG. 6 is a schematic diagram of real-time road conditions of the part of the road network in the Tianhe District according to an embodiment.

FIG. 7 is a MFD according to an embodiment.

### DESCRIPTION OF THE EMBODIMENTS

The present invention will be further described below with reference to the specific embodiments. The accompanying drawings are merely used for exemplary illustration and only represents schematic diagram rather than diagram of an actual product, thus it cannot be interpreted as a limit to the present application. In order to better illustrate the embodiment of the present invention, certain components in the accompanying drawings will be omitted, zoomed in or zoomed out, and do not represent the size of the actual product. To those skilled in the art, it can be understood that certain commonly known structure and its explanation in the accompanying drawings can be omitted.

The same or similar reference numbers in the accompanying drawings of the embodiment in the present invention correspond to the same or similar components. In the description of present invention, it needs to be understood that if the position indicated by terms such as “up”, “down”, “left” and “right” is based on the position or location relationship showed in the accompanying drawings. It is merely for describing the present invention and simplifies the description rather than indicating or implying that the referred device or parts must possess certain position and construct and operation with certain position. Therefore, terms describing position relationship in the accompanying drawings are merely used for exemplary description, and cannot be understood as a limit to the present invention. One with ordinary skills in the art can understand the specific meaning of above terms based on specific situation.

### Embodiment

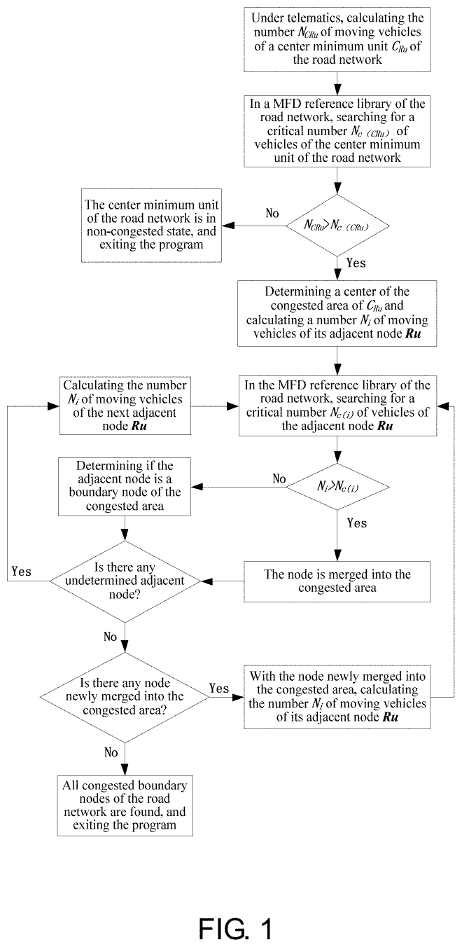

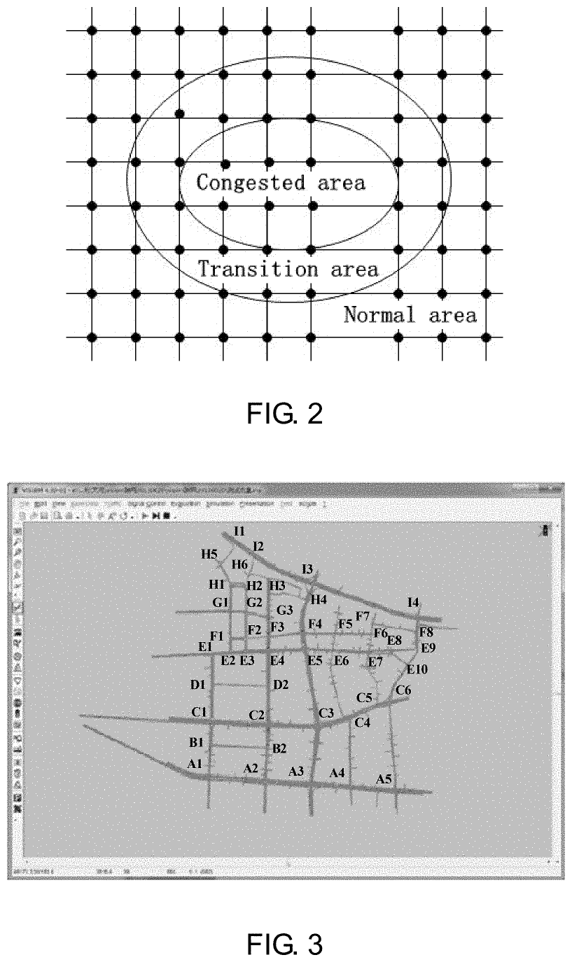

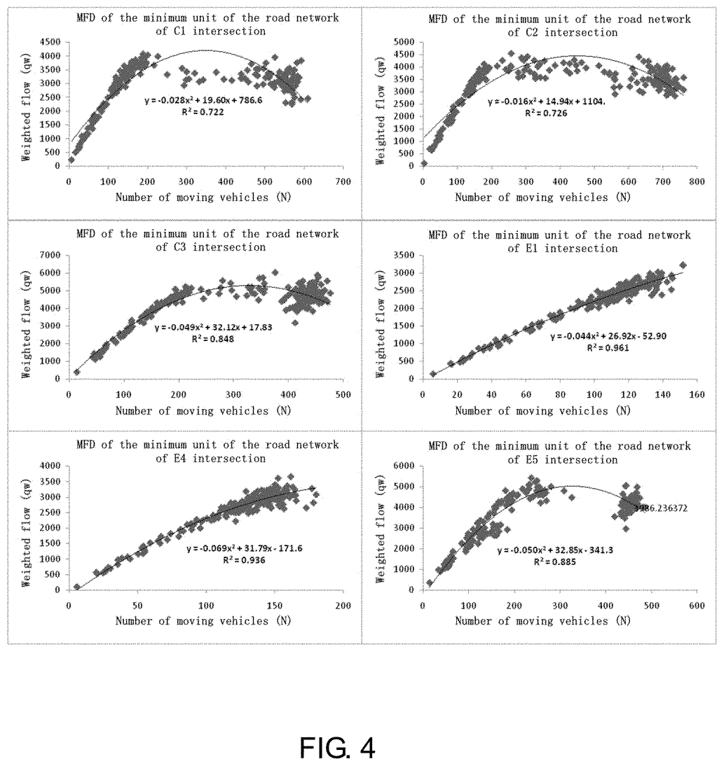

An embodiment of a method of dynamic division of multi-layer control boundary of an over-saturated road network based on MFD under telematics is shown in FIG. 1 to FIG. 7, and specific steps are as follows:

(a) firstly, establishing a road network model;

(b) after the step (a), establishing a MFD reference library of a road network;

(c) after the step (b), obtaining traffic parameters of the road network under an environment of telematics;

(d) after the step (c), under the environment of telematics, collecting a number NCRu of moving vehicles of a center minimum unit CRu of the road network in real time; according to the MFD reference library, determining a traffic state of the center minimum unit of the road network; if the center minimum unit of the road network is in a non-congested state, the road network does not have a congested area; if the center minimum unit of the road network is in a congested state, it is defined as a congested area; then judging a traffic state of a minimum unit of the road network of adjacent nodes thereof to determine a boundary node of the congested area; and

(e) after the step (d), defining a peripheral node near the boundary node of the congested area as a transition node, defining an area expanded by the periphery of the transition node as a traffic normal area, defining a peripheral node near the transition node as an inner node of the traffic normal area, defining a zone between the inner node of the traffic normal area and the boundary node of the congested area as a traffic transition area; by determining if road segments connected between the transition node and the traffic normal node are in the non-congested state or the congested state, it can thereby be judged that if boundary control are performed to these road segments and the boundary node is checked and approved.

In particular, in the step (a), road intersections are positioned as a node, each of the road segments is a line segment connecting each node, thereby a road network model based on connection of the road segments is established, and a formula is as follows:

$$\{ \begin{matrix}{R}_{w} = ( M , R , {L}_{R} ) \\ R = \{ ( i , j ) \text{\textbar} i , j ∈ M , and L ( i , j ) \} \\ {L}_{R} = \{ {l}_{ij} \text{\textbar} ( i , j ) ∈ R \}\end{matrix}$$

wherein R_{w} is a city road network;

M is a set of the intersections;

R is a set of the road segments, wherein elements thereof are ordered pairs (i, j), and L(i, j) indicates that there is a directed path from an intersection i to an intersection j;

L_{R} is a set of length of the road segments, wherein its element lij indicates a length of a directed road segment (i, j).

In addition, in the step (b), the step of establishing the MFD reference library of the road network is as follows:

(a) firstly, collecting the historical traffic data of the road network and generating a MFD of a minimum unit of each road network, and a formula is as follows:

$$\{ \begin{matrix}{N}_{i} = {\sum }_{ij} {k}_{ij} {l}_{ij} \\ {q}_{i}^{w} = {\sum }_{ij} {q}_{ij} {l}_{ij} \text{/} {\sum }_{ij} {l}_{ij}\end{matrix}$$

wherein Nᵢ is a number (pcu) of the moving vehicles of the minimum unit of the road network at an i-th node;

kᵢⱼ is a traffic density (pcu/km) of the minimum unit of the road network of the i-th node;

Iᵢⱼ is a road length (km) from the i-th node to an adjacent j-th node;

qᵢ^{w} is an amount (pcu/h) of a weighted traffic flow of the minimum unit of the road network of the i-th node;

qᵢⱼ is a flow (pcu/h) from the i-th node to the adjacent j-th node; and

(b) secondly, according to the MFD of the minimum unit of the road network at certain node, determining a critical number of vehicles and a maximum weighted traffic flow of the minimum unit of the road network at this node, and establishing the MFD reference library of the minimum unit of all road networks, and a formula is as follows:

MFD_{w}={(N_{C(i)},q_{c(i)}^{w})|∈M}

wherein MPD_{w} is a set of the MFD of the minimum unit of the road network at all nodes of the road networks;

N_{C(i)} is a critical number of vehicles of the minimum unit of the road network at the i-th node;

q_{c(i)}^{w} is an amount of a weighted traffic flow of the minimum unit of the road network of the i-th node.

In particular, in the step (c), a ray method is used to judge whether a vehicle falls within a road network area, and specific steps are as follows: directing a ray from a latitude and longitude point of the vehicle to be judged to a certain direction, and calculating a number of intersections with boundaries of the road network. If the number is even or 0, the point is outside the road network area. If the number is odd, the point is inside the road network area.

In addition, in the step (c), a number of vehicles falling within the road network area is converted into an equivalent amount of traffic, and a number Nᵢⱼ of vehicles of each road segment in the road network and an amount qᵢⱼ of a traffic flow of each road segment are determined (ij represents a road segment from the i-th node to an adjacent node j), thereby a traffic density K_{Ru(i)} of the minimum unit of each road network in the road networks is calculated. An average value of the traffic density of each road segment that connects a certain node, is defined a traffic density of the minimum unit of the road network of this node, and a formula is as follows:

$$\{ \begin{matrix}{k}_{ij} = \frac{{N}_{ij}}{{l}_{ij} * {n}_{ij}} , and {l}_{ij} \neq 0 \\ {K}_{i} = \{ ( {k}_{ij} \text{\textbar} i , j ∈ R , and {l}_{ij} \neq 0 \} \\ {K}_{Ru ( i )} = {\overline{K}}_{i}\end{matrix}$$

wherein Nᵢⱼ is a number (pcu) of moving vehicles of a road segment from the i-th node to the adjacent j-th node;

lᵢⱼ is a length (km) of the road segment from the i-th node to the adjacent j-th node;

nᵢⱼ is a number of lanes of the road segment from the i-th node to the adjacent j-th node;

kᵢⱼ is a traffic density (pcu/km) of the road segment from the i-th node to the adjacent j-th node;

Kᵢ is a set of the traffic density of each road segment that connects with the i-th node;

K̅ᵢ is an average value (pcu/km) of traffic density values of the i-th node;

K_{Ru(i)} is a traffic density (pcu/km) of the minimum unit of the road network of the i-th node.

In particular, in the step (c), a node with a maximum value of average traffic density is used as a center key node of the road network, each road segment that connects with the center key node together form a center minimum unit CRu of the road network and a formula is as follows:

Kₘₐₓ=max(K_{Ru(i)},K_{Ru(2)}, . . . ,K_{Ru(i)}, . . . ,K_{Ru(n)})

wherein Kₘₐₓ is a traffic density (pcu/km) of the minimum unit of the center key node of the road network.

In addition, in the step (d), specific steps of determining the boundary node of the congested area are as follows: defining the center minimum unit of the road network in the congested state as the congestion area; then judging a traffic state of the minimum unit of the road network of an adjacent node. If the minimum unit of the adjacent node is in the non-congested state, the adjacent node is the boundary node of the congested area, and it is continued to judge the traffic state of the minimum unit of the next adjacent node. If the minimum unit of the adjacent node is in the congested state, the adjacent node is merged into the congestion area, and it is continued to judge the traffic state of the minimum unit of the next adjacent node. Then, the node newly merged into the congestion area is taken as a research object, and it is continued to judge the traffic state of the minimum unit of the road network of the adjacent node thereof until the boundary node of the congestion area is determined.

In particular, an embodiment of a specific application is as follows: a part of the road network in Tianhe District, Guangzhou is used as an embodiment, and the method of dynamic division of multi-layer control boundary of a road network is verified.

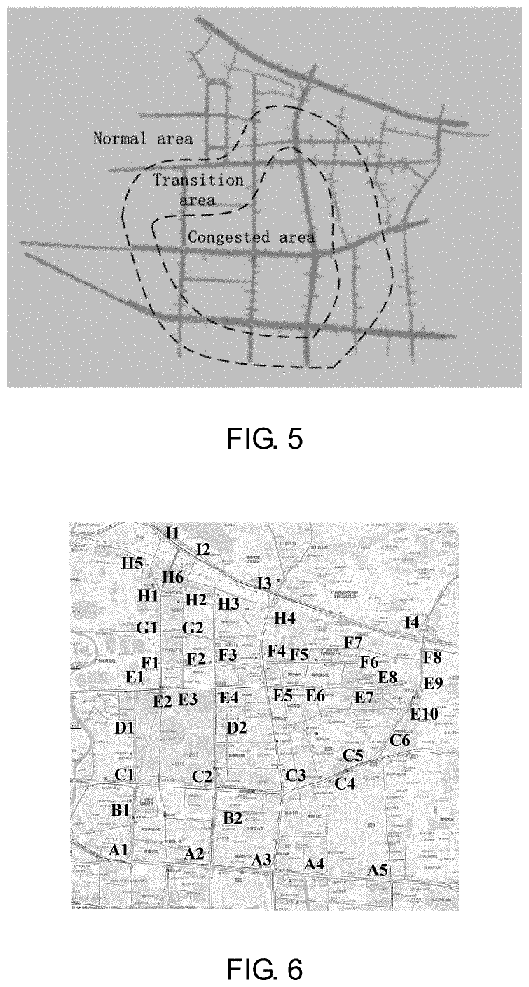

The road network consists of main roads such as Guangyuan Expressway, Tianhe Road, Tianhe East Road, Tianhe North Road and Huangpu Avenue, and some branch roads, including 8 interchanges, over 20 plane intersections, and over 90 entrances and exits. Vissim traffic simulation software is used to establish a micro-simulation model of the road network according to information such as situations of lane layouts of actual road lanes, schemes of signal control, and traffic organization of the road network and so on, as shown in FIG. 5.

A traffic flow data is based on the data detected by the SCATS traffic signal control system during the peak hours (18:00-19:00) on Aug. 6, 2017. In order to simulate an entire process of the road network from non-saturation to over-saturation, the traffic of each road segment of the boundary of the road network increases by 100 pcu/h every 900 s until the over-saturated state of the peak is reached. A total of 27000 s is simulated, and a data is collected once every 120 s. A total of 225 data are collected. Finally, a number of moving vehicles of the minimum unit of the road network (calculated by the road segment density ki*the road segment length Li), a traffic inflow and traffic outflow of the boundary intersection, and a flow of the road segment are counted and processed. The MFD reference library of all the minimum units of the road network is obtained, and wherein the MFD of the minimum unit of the road network of a part of the intersections is shown in FIG. 6.

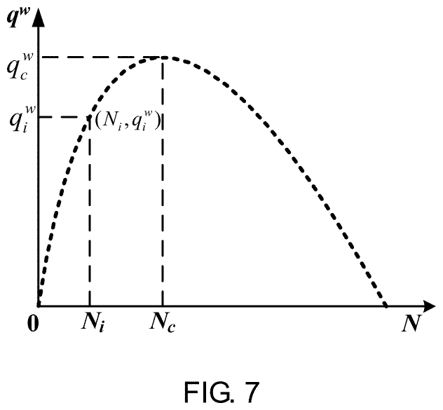

During the entire process of the traffic flow change of the road network, a secondary development interface of Vissim software is used, and a method of dynamic division of multi-layer control boundary is implemented with C # language. The multi-layer control boundary of the road network is finally determined, and wherein the congested area contains 6 intersections as shown in FIG. 7. In order to verify the effectiveness of the algorithm of the present invention, a real-time traffic diagram of the road network at 19:00 on Aug. 6, 2017 is captured on Baidu map, as shown in FIG. 8. As can be seen from FIG. 8, the congestion is mainly distributed on the road segments intersecting 5 intersections of A2, A3, C1, C2, C3 and E5. It can be seen that the multi-layer control boundary divided by the algorithm of the present invention is identical with the actual road condition.

Obviously, the above embodiments are merely examples made for clearly illustrating the present invention rather than limiting the embodiments of the present invention. To one with ordinary skills in the art, other forms of modifications or variants can be made based on the above description. There is no need and also impossible to put forward an exhaustive list of all embodiments. Any modifications, equivalents and improvements made within the spirit and principle of the present invention should all be included in the scope of protection claimed in the present invention.

1. A method of dynamic division of multi-layer control boundary of an over-saturated road network based on MFD under telematics, wherein the method comprises specific steps as follows:
(a) firstly, establishing a road network model;
(b) after the step (a), establishing a MFD reference library of a road network;
(c) after the step (b), obtaining traffic parameters of the road network under an environment of telematics;
(d) after the step (c), under the environment of telematics, collecting a number NCRu of moving vehicles of a center minimum unit CRu of the road network in real time; according to the MFD reference library, determining a traffic state of the center minimum unit of the road network; if the center minimum unit of the road network is in a non-congested state, the road network does not have a congested area; if the center minimum unit of the road network is in the congested state, it is defined as the congested area; then judging a traffic state of a minimum unit of the road network of adjacent nodes thereof to determine a boundary node of the congested area; and
(e) after the step (d), defining a peripheral node near the boundary node of the congested area as a transition node, defining an area expanded by the periphery of the transition node is as a traffic normal area, defining a peripheral node near the transition node as an inner node of the traffic normal area, defining a zone between the inner node of the traffic normal area and the boundary node of the congested area as a traffic transition area; by determining if road segments connected between the transition node and the traffic normal node are in the non-congested state or the congested state, it can thereby be judged that if boundary control are performed to these road segments and the boundary node is checked and approved.

2. The method of dynamic division of multi-layer control boundary of the over-saturated road network based on MFD under telematics according to claim 1, wherein in the step (a), road intersections are positioned as nodes, each of the road segments is a line segment connecting each node, thereby a road network model based on connection of the road segments is established, and a formula is as follows:
$$\{ \begin{matrix}{R}_{w} = ( M , R , {L}_{R} ) \\ R = \{ ( i , j ) \text{\textbar} i , j ∈ M , and L ( i , j ) \} \\ {L}_{R} = \{ {l}_{ij} \text{\textbar} ( i , j ) ∈ R \}\end{matrix}$$
wherein R_{w} is a city road network;
M is a set of the intersections;
R is a set of the road segments, wherein elements thereof are ordered pairs (i, j), and L(i, j) indicates that there is a directed path from an intersection i to an intersection j;
L_{R} is a set of length of the road segments, wherein its element lij indicates a length of a directed road segment (i, j).

3. The method of dynamic division of multi-layer control boundary of the over-saturated road network based on MFD under telematics according to claim 2, wherein in the step (b), the step of establishing the MFD reference library of the road network is as follows:
(a) firstly, collecting the historical traffic data of the road network and generating a MFD of a minimum unit of each road network, and a formula is as follows:
$$\{ \begin{matrix}{N}_{i} = {\sum }_{ij} {k}_{ij} {l}_{ij} \\ {q}_{i}^{w} = {\sum }_{ij} {q}_{ij} {l}_{ij} \text{/} {\sum }_{ij} {l}_{ij}\end{matrix}$$
wherein Nₖ is a number (pcu) of the moving vehicles of the minimum unit of the road network at an i-th node;
kᵢⱼ is a traffic density (pcu/km) of the minimum unit of the road network of the i-th node;
lᵢⱼ is a road length (km) from the i-th node to an adjacent j-th node;
qᵢ^{w} is an amount (pcu/h) of a weighted traffic flow of the minimum unit of the road network of the i-th node;
qᵢⱼ is a flow (pcu/h) from the i-th node to the adjacent j-th node; and
(b) secondly, according to the MFD of the minimum unit of the road network at a certain node, determining a critical number of vehicles and a maximum weighted traffic flow of the minimum unit of the road network at this node, and establishing the MFD reference library of the minimum unit of all road networks; a formula is as follows:
MFD_{w}={( )|i∈M}
wherein MFD_{w} is a set of the MFD of the minimum unit of the road network at all nodes of the road networks;
N_{C(i)} is a critical number of vehicles of the minimum unit of the road network at the i-th node;
q_{c(i)}^{w} is an amount of a weighted traffic flow of the minimum unit of the road network of the i-th node.

4. The method of dynamic division of multi-layer control boundary of the over-saturated road network based on MFD under telematics according to claim 3, wherein in the step (c), a ray method is used to judge whether a vehicle falls within a road network area, and specific steps are as follows: directing a ray from a latitude and longitude point of the vehicle to be judged to a certain direction, and calculating a number of intersections with boundaries of the road network; if the number is even or 0, the point is outside the road network area; if the number is odd, the point is inside the road network area.

5. The method of dynamic division of multi-layer control boundary of the over-saturated road network based on MFD under telematics according to claim 4, wherein in the step (c), a number of vehicles falling within the road network area is converted into an equivalent amount of traffic, and a number Nᵢⱼ of vehicles of each road segment in the road network and an amount qᵢⱼ of a traffic flow of each road segment are determined (ij represents a road segment from the i-th node to an adjacent node j), thereby a traffic density K_{Ru(i)} of the minimum unit of each road network in the road networks is calculated; an average value of the traffic density of each road segment that connects a certain node, is defined a traffic density of the minimum unit of the road network of this node, and a formula is as follows:
$$\{ \begin{matrix}{k}_{ij} = \frac{{N}_{ij}}{{l}_{ij} * {n}_{ij}} , and {l}_{ij} \neq 0 \\ {K}_{i} = \{ ( {k}_{ij} \text{\textbar} i , j ∈ R , and {l}_{ij} \neq 0 \} \\ {K}_{Ru ( i )} = {\overline{K}}_{i}\end{matrix}$$
wherein Nᵢⱼ is a number (pcu) of moving vehicles of a road segment from the i-th node to the adjacent j-th node;
lᵢⱼ is the length (km) of the road segment from the i-th node to the adjacent j-th node;
nᵢⱼ is a number of lanes of the road segment from the i-th node to the adjacent j-th node;
kᵢⱼ is the traffic density (pcu/km) of the road segment from the i-th node to the adjacent j-th node;
Kᵢ is a set of the traffic density of each road segment that connects with the i-th node;
K̅ᵢ is an average value (pcu/kmn) of traffic density of the i-th node;
K_{Ru(i)} is a traffic density (pcu/km) of the minimum unit of the road network of the i-th node.

6. The method of dynamic division of multi-layer control boundary of the over-saturated road network based on MFD under telematics according to claim 5, wherein in the step (c), a node with a maximum value of average traffic density is used as a center key node of the road network, each road segment that connects with the center key node together form the center minimum unit C_{Ru} of the road network, and a formula is as follows:
Kₘₐₓ=max(K_{Ru(1)},K_{Ru(2)}, . . . ,K_{Ru(i)}, . . . ,K_{Ru(n)})
wherein Kₘₐₓ is a traffic density (pcu/km) of the minimum unit of the center key node of the road network.

7. The method of dynamic division of multi-layer control boundary of the over-saturated road network based on MFD under telematics according to claim 5, wherein in the step (d), specific steps of determining the boundary node of the congested area are as follows:
defining the center minimum unit of the road network in the congested state as the congestion area; then judging the traffic state of the minimum unit of the road network of the adjacent node; if the minimum unit of the adjacent node is in the non-congested state, the adjacent node is the boundary node of the congested area, and it is continued to judge the traffic state of the minimum unit of the next adjacent node; if the minimum unit of the adjacent node is in the congested state, the adjacent node is merged into the congestion area, and it is continued to judge the traffic state of the minimum unit of the next adjacent node; then, the node newly merged into the congestion area is taken as a research object, and it is continued to judge the traffic state of the minimum unit of the road network of the adjacent node thereof until the boundary node of the congestion area is determined.
